(19) United States
(12) Patent Application Publication
(10) Pub. No.: US 2025/0307617 A1
(43) Pub. Date: Oct. 2, 2025

(54) SPIKING NEURAL NETWORK AND METHOD OF DRIVING SPIKING NEURAL NETWORK

(71) Applicant: ELECTRONICS AND TELECOMMUNICATIONS RESEARCH INSTITUTE, Daejeon (KR)

(72) Inventors: Kyuseung HAN, Daejeon (KR); Kwang IL OH, Daejeon (KR); Sukho LEE, Daejeon (KR); Jae-Jin LEE, Daejeon (KR)

(21) Appl. No.: 19/089,271

(22) Filed: Mar. 25, 2025

(30) Foreign Application Priority Data
Mar. 26, 2024 (KR) 10-2024-0041128
Jul. 8, 2024 (KR) 10-2024-0089423

(51) Int. Cl. G06N 3/049; G06N 3/063

(52) U.S. Cl. CPC G06N 3/049; G06N 3/063

(57) ABSTRACT

Provided is a method of driving a spiking neural network that includes one or more neurons including synapses, a membrane capacitor for forming membrane potential, a threshold capacitor for forming threshold potential, and a neuron circuit. The method includes: integrating signals from one or more synapses storing positive valued weight in the membrane capacitor to form the membrane potential; integrating signals from the synapses storing negative valued weight in the threshold capacitor to form the threshold potential; discharging the membrane capacitor when the membrane potential exceeds discharge potential, discharging the threshold capacitor when the threshold potential exceeds the discharge potential, and counting difference in the number of times the membrane capacitor is discharged; and firing an output signal according to the difference in the number of times of the discharge and difference between potential after the membrane capacitor is discharged and potential after the threshold capacitor is discharged.

### CROSS-REFERENCE TO RELATED APPLICATIONS

This application claims priority to and the benefit of Korean Patent Application Nos. 10-2024-0041128, filed on Mar. 26, 2024, and 10-2024-0089423, filed on Jul. 8, 2024, the disclosure of which is incorporated herein by reference in its entirety.

### BACKGROUND

### 1. Field of the Invention

The present disclosure generally relates to a spiking neural network and a method of driving a spiking neural network.

### 2. Description of Related Art

A neural network is one method of implementing an artificial intelligence network that generates a series of outputs through computations on applied spike inputs. When an intermittent (non-periodic) or periodic spike is applied to an input (axon) of the network, a network computation according to the input is performed at a specific node, and the spike is transmitted to the next node (or the next spike neural network) along a preset spike transmission path.

The elements that perform the network computation according to the spike input largely include two matters. The first element is a synapse, which applies a synaptic weight of the corresponding node to the spike applied from the input (axon) and then transmits the result to an input (dendrite) of a neuron to which the synapse is connected.

Multiple synapses may be connected to the dendrite which is the input of the neuron, and spikes received from multiple other axons are processed according to the weights stored at each synapse and transmitted to the input of the same neuron.

The second element is a neuron. The results of each transmitted synaptic computation are integrated in a membrane where the dendrites are gathered to form a membrane potential, and a neuron fires at the moment when the integrated potential exceeds a threshold for firing of the neuron to output a short pulse, i.e., a spike.

When characterizing this mechanism, the spikes input to each of the multiple axons are transmitted to the synapse while having their own input timings. The weight of the synapse is a value corresponding to the relationship between a pre-synaptic neuron and a post-synaptic neuron, and the magnitude (the degree of influence) of the signal to be transmitted to the membrane where the input spike as the input of the neuron is implemented in the dendrite is determined by the weight of the synapse. These signals are integrated in the membrane, so the corresponding neuron fires.

This mechanism may be implemented as a semiconductor circuit composed of Metal-Oxide-Semiconductor Field-Effect Transistors (MOSFETs) to express the synaptic computation in the form of a charge computation. The input of the axon is applied to a gate of a MOSFET, and the weight of the synapse is connected to gates of MOSFETs connected in series with the gate of the MOSFET so that the amount of current flowing through the two MOSFETs connected in series may be controlled, the amount of current or charge according to the controlled amount of current is stored and accumulated in a membrane capacitor connected to the input of the neuron circuit, and the membrane potential is transmitted to the neuron circuit.

### SUMMARY OF THE INVENTION

The mechanism of the synapse of the conventional spiking neural network (SNN) essentially reflects a biological model. That is, when the potential integrated in the membrane of the neuron reaches a critical potential, the neuron generates an output spike. The spike train is transmitted to the neurons connected to each other through the synapse, and the membrane potential of the firing neuron is reset.

This mechanism may cause an overflow problem when the amount of charge exceeds the capacity that the membrane capacitor may express. The overflow during the integration process may cause serious operational errors. There may be a method of handling overflow through increasing of the capacity of the membrane capacitor. However, the method of increasing capacitor capacity has the drawback of increasing power consumption and a die area, which reduces economic efficiency.

That is, the spiking neural network has characteristics of an analog circuit by simulating an operation of a biological brain, but there are limitations from a computing perspective when implementing the operation with only an analog circuit.

The present embodiment is intended to resolve these difficulties of the conventional technologies.

According to an aspect of the present invention, there is provided a spiking neural network that includes a plurality of neurons, in which each of the plurality of neurons includes: a plurality of synapses, each of which stores a positive valued weight or a negative valued weight; a membrane capacitor that integrates signals output from one or more synapses storing the positive valued weight to form a membrane potential; a threshold capacitor that integrates the signals output from the one or more synapses storing the negative valued weight to form a threshold potential, and a neuron circuit that discharges the membrane capacitor when the membrane potential exceeds a discharge potential and discharges the threshold capacitor when the threshold potential exceeds the discharge potential, in which the neuron circuit fires the output signal according to a difference between the number of times the membrane capacitor is discharged and the number of times the threshold capacitor is discharged and a difference between the potential of the membrane capacitor and the potential of the threshold capacitor.

Each of the plurality of synapses may include: a first synaptic subunit that stores the positive valued weight; and a second synaptic subunit that stores the negative valued weight, and one of the first synaptic subunit and the second synaptic subunit is activated according to the stored weight. The activated first synaptic subunits may be connected to the same membrane capacitor within the same neuron to provide an output, and the activated second synaptic subunits may be connected to the same threshold capacitor within the same neuron to provide an output.

The neuron circuit may include a counter, and the neuron circuit may change a counting result of the counter in the first direction by the number of times the membrane capacitor is discharged and change the counting result of the counter in a second direction opposite to the first direction by the number of times the threshold capacitor is discharged according to the number of times the threshold capacitor is discharged. The neuron circuit may further include a comparator, and the comparator may output a comparison result of comparing the membrane potential of the membrane capacitor with the threshold potential of the threshold capacitor. The neuron circuit may further include a logic circuit, and the logic circuit may generate and output a firing signal when the counting result of the counter corresponds to the number of times the membrane capacitor is discharged being greater than the number of times the threshold capacitor is discharged and when the comparison result of the comparator corresponds to the membrane potential of the membrane capacitor being greater than the threshold potential of the threshold capacitor. The neuron circuit may reset both the membrane capacitor and the threshold capacitor when the firing signal is output.

The neuron circuit may discharge the membrane capacitor by charging the membrane capacitor to a limiting potential lower than or equal to the discharge potential when the membrane potential is greater than or equal to than the discharge potential and discharge the threshold capacitor by charging the threshold capacitor to a limiting potential lower than the discharge potential when the threshold potential is greater than or equal to the discharge potential.

According to another aspect of the present invention, there is provided a method of driving a spiking neural network including one or more neurons that include a plurality of synapses, a membrane capacitor for forming a membrane potential, a threshold capacitor for forming a threshold potential, and a neuron circuit, the method including: integrating signals output from the one or more synapses storing a positive valued weight in the membrane capacitor and forming the membrane potential; integrating signals output from the one or more synapses storing a negative valued weight in the threshold capacitor and forming the threshold potential; discharging the membrane capacitor when the membrane potential exceeds a discharge potential, discharging the threshold capacitor when the threshold potential exceeds the discharge potential, and counting a difference in the number of times the membrane capacitor is discharged; and firing an output signal according to the difference in the number of times of the discharge and a difference between a potential after the membrane capacitor is discharged and a potential after the threshold capacitor is discharged.

Each of the forming of the membrane potential, the discharging of the membrane capacitor, the forming of the threshold potential, and the discharging of the threshold capacitor may be performed independently.

In the discharging of the membrane capacitor when the membrane potential exceeds the discharge potential, the discharging of the threshold capacitor when the threshold potential exceeds the discharge potential, and the counting of the difference in the number of times the membrane capacitor is discharged, the neuron circuit may change a counting result of the counter in a first direction when discharging the membrane capacitor and change the counting result of the counter in a second direction opposite to the first direction when discharging the threshold capacitor.

Each of the plurality of synapses may include: a first synaptic subunit that stores the positive valued weight; and a second synaptic subunit that stores the negative valued weight, and one of the first synaptic subunit and the second synaptic subunit is activated according to the stored weight.

The activated first synaptic subunits may be connected to the same membrane capacitor within the same neuron to provide an output, and the activated second synaptic subunits may be connected to the same threshold capacitor within the same neuron to provide an output.

The neuron circuit further includes a comparator, and the comparator may output a comparison result of comparing the membrane potential after the membrane capacitor is discharged with the threshold potential after the threshold capacitor is discharged.

The neuron circuit further may include a logic circuit, and the logic circuit may generate and output a firing signal when a result in the counting corresponds to the number of times the membrane capacitor is discharged being greater than the number of times the threshold capacitor is discharged and a result in the comparing corresponds to the membrane potential of the membrane capacitor being greater than the threshold potential of the threshold capacitor.

The method may further include, after the firing of the output signal, resetting the membrane capacitor and the threshold capacitor by discharging both the membrane capacitor and the threshold capacitor.

The discharging of the membrane capacitor may be performed by discharging the membrane capacitor by charging the membrane capacitor with a limiting potential lower than the discharge potential, and the discharging of the threshold capacitor may be performed by discharging the threshold capacitor by charging the threshold capacitor with the limiting potential lower than the discharge potential.

### BRIEF DESCRIPTION OF DRAWINGS

The above and other objects, features, and advantages of the present invention will become more apparent to those of ordinary skill in the art by describing exemplary embodiments thereof in detail with reference to the accompanying drawings, in which:

FIG. 1 is a diagram schematically illustrating an operation of a spiking neural network according to the present embodiment;

FIG. 2 is a diagram schematically illustrating the relationship between a spike signal output from a pre-neuron of a spiking neural network according to the present embodiment and a post-neuron and a synapse;

FIG. 3 is a diagram schematically illustrating the spiking neural network according to the present embodiment;

FIG. 4 is a diagram schematically illustrating spiking signals output from a synapse that stores a positive valued weight and a profile of a membrane potential formed the spiking signals;

FIG. 5 is a flowchart schematically describing the present embodiment; and

FIG. 6 is a schematic diagram for describing the present embodiment.

### DETAILED DESCRIPTION OF EXEMPLARY EMBODIMENTS

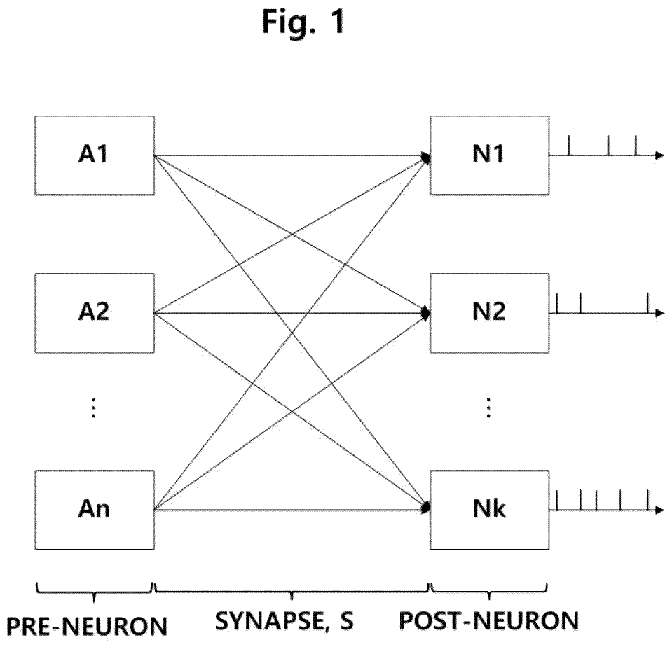

Hereinafter, the present embodiment will be described with reference to the accompanying drawings. FIG. 1 is a diagram schematically illustrating an operation of a spiking neural network according to the present embodiment. Referring to FIG. 1, a spiking neural network (SNN) may include pre-neurons A1, A2, . . . , An, post-neurons N1, N2, . . . , Nk, and synapses S connecting the pre-neurons and the post-neurons with weights corresponding to their connection strengths. As illustrated, the pre-neurons A1, A2, . . . , An may be positioned before the post-neurons N1, N2, . . . , Nk in a signal flow.

The pre-neurons A1, A2, . . . , An may each output a signal in the form of a spike. The synapses S may receive the output spikes and transmit spike signals, which are weighted by weights, to the post-neurons N1, N2, . . . , Nk. Even if the spike signal is output from any one of the pre-neurons and provided to neurons, the weights, which are connection strengths between the pre-neurons and the post-neurons, may be different, so the spike signals transmitted to the post-neurons N1, N2, . . . , Nk may be different.

Each of the post-neurons N1, N2, . . . , Nn may receive the spike signals transmitted from the synapses S. Each of the post-neurons N1, N2, . . . , Nn that have received the spike signals may output the spikes based on the received spike signals. Although not illustrated, the spike signals output from each of the post-neurons N1, N2, . . . , Nn may be output to neurons subsequent to the post-neurons. Similarly, the synapses corresponding to each connection strength may be positioned between each of the post-neurons N1, N2, . . . , Nn and each of the subsequent neurons.

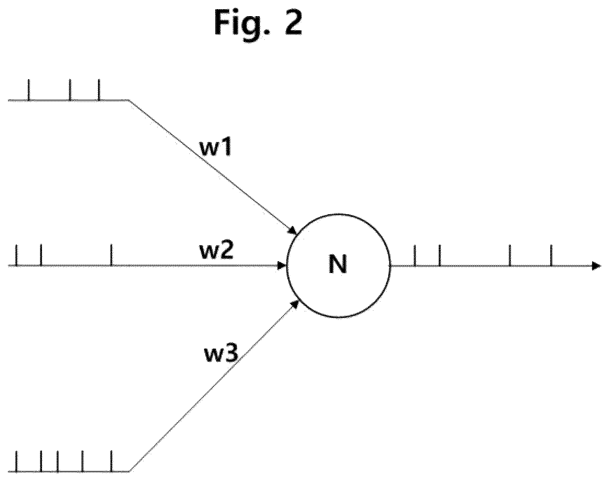

FIG. 2 is a diagram schematically illustrating the relationship between the spike signal output from the pre-neuron of the spiking neural network of the present embodiment and the post-neuron N and the synapse. Referring to FIG. 2, a spike fired from a pre-neuron is input to the post-neuron N through the synapse. The spike signal is provided to the post-neuron N with a different size depending on weights w1, w2, and w3 between each pre-neuron and each post-neuron. The post-neuron N integrates the spike signals with different sizes and generates and outputs the spike signals when the integrated result is greater than or equal to a threshold.

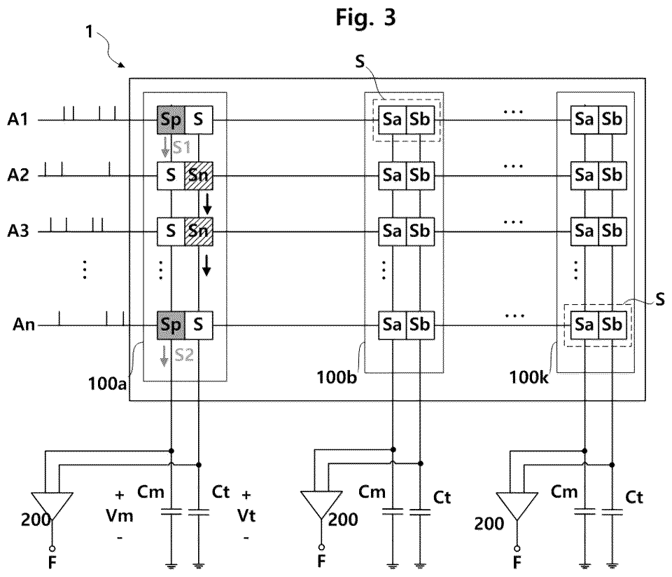

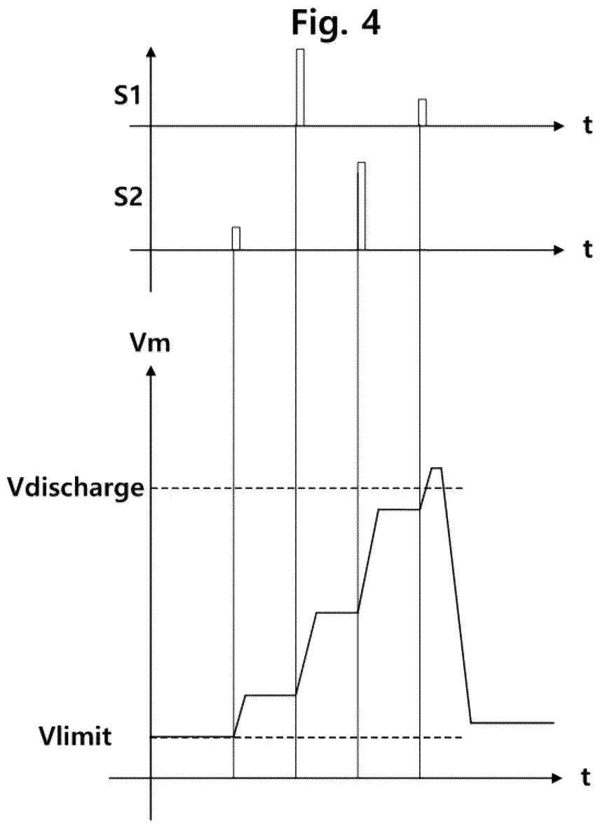

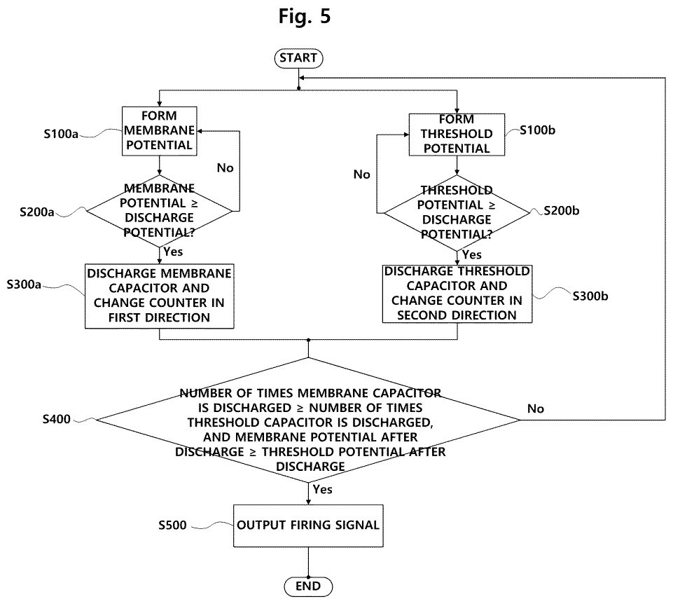

FIG. 3 is a diagram schematically illustrating the spiking neural network according to the present embodiment, FIG. 4 is a diagram illustrating profiles of spiking signals S1 and S2 output from synapses storing positive valued weights and a membrane potential Vm formed therefrom, and FIG. 5 is a flowchart schematically describing the present embodiment.

Referring to FIGS. 3 to 5, the spiking neural network 1 of the present embodiment includes: a plurality of neurons 100. Each of the plurality of neurons 100 includes: a plurality of synapses S, each of which stores positive valued weights or negative valued weights; a membrane capacitor Cm that integrates signals output from one or more synapses Sp storing positive valued weights to form the membrane potential Vm; a threshold capacitor Ct that integrates signals output from one or more synapses Sn storing negative valued weights to form a threshold potential Vt; and a neuron circuit 200 that discharges the membrane capacitor Cm when the membrane potential Vm exceeds a discharge potential Vdischarge (see FIG. 4) and discharges a threshold capacitor Ct when the threshold potential Vt exceeds the discharge potential. The neuron circuit 200 outputs an output signal F according to a difference between the number of times the membrane capacitor Cm is discharged and the number of times the threshold capacitor Ct is discharged and a difference between a potential after the membrane capacitor Cm is discharged and a potential after the threshold capacitor Ct is discharged.

In addition, the method of driving a spiking neural network according to the present embodiment includes integrating signals output from one or more synapses storing positive valued weights in the membrane capacitor Cm to form the membrane potential Vm (S100a); integrating signals output from one or more synapses storing negative valued weights in the threshold capacitor Ct to form the threshold potential Vt (S100b); discharging the membrane capacitor Cm when the membrane potential Vm exceeds the discharge potential Vdischarge (S200a and S300a), discharging the threshold capacitor Ct when the threshold potential Vt exceeds the discharge potential Vdischarge (S200b and S300b), and counting the difference between the number of times the membrane capacitor Cm is discharged and the number of times the threshold capacitor Ct is discharged; and detecting the difference in the number of times of the discharge and a difference between a potential after the membrane capacitor is discharged and a potential after the threshold capacitor is discharged (S400) and providing an output signal according to the detection result.

In an embodiment not illustrated, the method of driving a spiking neural network may further include, after outputting the firing signal, resetting by the neuron circuit 200, the threshold capacitor Ct and the membrane capacitor Cm by discharging the threshold capacitor Ct and the membrane capacitor Cm.

Referring to FIGS. 3 and 4, neurons 100a, 100b, . . . , 100k of the spiking neural network 1 according to the present embodiment include the plurality of synapses S to which the spike signals output from free neurons A1, A2, A3, . . . , An are input, the membrane capacitor Cm forming the membrane potential, the threshold capacitor Ct forming the threshold potential, and the neuron circuit 200.

In an embodiment, the synapse S includes first synaptic subunits Sa to which the positive valued weights are provided and stored and second synaptic subunits Sb in which the negative valued weights are provided and stored. The first synaptic subunits Sa are connected to each other within the same neuron and output an output signal through the same line. The second synaptic subunits Sb are connected to each other within the same neuron and output an output signal through the same line.

In one synapse S, either the positive valued weight or the negative valued weight is stored in the first synaptic subunit Sa or the second synaptic subunit Sb. In the synapse S, the first synaptic subunit or the second synaptic subunit in which the weight is stored is activated, and the synaptic subunit in which the weight is not stored is deactivated. Therefore, in the computation process, only the synaptic subunit that has stored the weight participates in the computation.

The spiking signals are provided from the free neurons A1, A2, A3, . . . , An. The spiking signals are applied to the synapses included in each neuron. Each activated synapse S forms signals according to the stored weights and outputs the signals. As described above, the synapse S may have a positive valued weight of 0. In addition, unlike a biological model, the synapse S may have a negative valued weight, which may be due to a backpropagation algorithm widely used in a learning framework.

In the present embodiment, when signals are output from the synapses Sp in which the positive valued weights are stored, the signals are integrated in the membrane capacitor Cm, and when signals are output from the synapses Sn where the negative valued weights are stored, the signals are integrated in the threshold capacitor Ct. In the example illustrated in FIG. 3, the synapses Sp where the positive valued weights are stored in the first neuron 100a are indicated by gray shading, and the signals output from the synapses Sp are illustrated by gray arrows. In addition, the synapses Sn storing the negative valued weights are hatched, and the signals output from the synapses Sn are illustrated by black arrows.

In the illustrated embodiment, the signals output from the synapses Sp storing the positive valued weights in the first neuron 100a are stored in the membrane capacitor Cm through the connected line to form the membrane potential Vm. In addition, the signals output from the synapses Sn storing the negative valued weights in the first neuron 100a are stored in the threshold capacitor Ct through the connected line to form the threshold potential Vt.

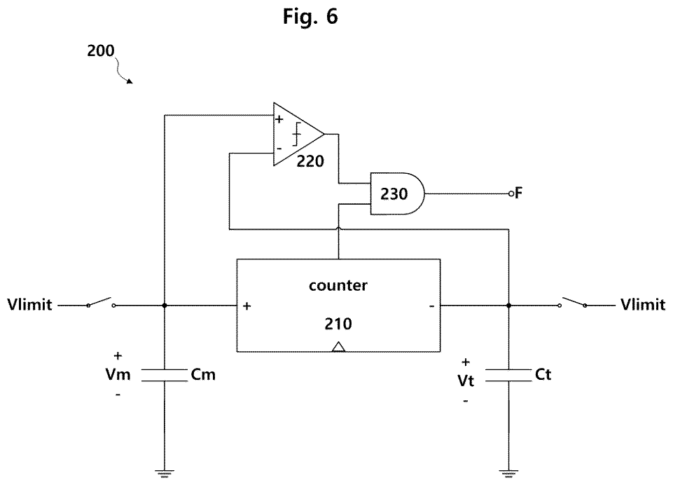

FIG. 6 is a schematic diagram for describing the present embodiment. Referring to FIGS. 3 to 6, the neuron circuit 200 includes a switch that electrically connects the membrane capacitor to a limiting voltage source Vlimit to discharge the membrane capacitor Cm, and a switch that electrically connects the threshold capacitor Ct to the limiting voltage source Vlimit to discharge the threshold capacitor Ct.

When the voltage Vm charged in the membrane capacitor Cm reaches the discharge voltage Vdischarge, overflow may occur as the spike signals input subsequently are integrated. Similarly, when the voltage Vt charged in the threshold capacitor Ct reaches the discharge voltage Vdischarge, overflow may occur as the spike signals input subsequently are integrated.

When the signals are output from the synapses Sp with the positive valued weights, a spike may occur due to the overflow during the process of integrating the signals, which may not affect the computational result. However, when the signals are output from the synapses with the negative valued weights, the spike may not occur even though the membrane potential exceeds the threshold potential for forming the spike. Therefore, when the negative valued weight is used, the overflow or underflow may occur during the integration process, which may cause unavoidable operational errors.

When the voltage Vm charged in the membrane capacitor Cm is higher than or equal to the discharge voltage, the neuron circuit 200 discharges the charge charged in the membrane capacitor Cm by conducting the switch connected to the limit voltage source Vlimit and charges the membrane capacitor Cm to the limit voltage Vlimit. In addition, when the voltage Vt charged in the threshold capacitor Ct is higher than or equal to the discharge voltage, the neuron circuit 200 discharges the charge charged in the threshold capacitor Ct by conducting the switch connected to the limit voltage source Vlimit and charges the threshold capacitor Ct to the limit voltage Vlimit.

In an embodiment, the discharge voltage may be any one of voltages ranging from 40% to 60% of VDD, which is a driving voltage provided to the spiking neural network, and the limit voltage source Vlimit may be any one of voltages ranging from 4% to 6% of VDD, which is a driving voltage provided to the spiking neural network. For example, when the driving voltage is 9 V, the discharge voltage may be 4.5 V, and the limit voltage Vlimit may be 0.45 V.

The neuron circuit 200 may include a counter 210 that moves counting results for each discharge of the membrane capacitor Cm in a first direction and moves counting results for each discharge of the threshold capacitor Ct in a second direction. The neuron circuit 200 changes the counting results of the counter in the first direction by providing a signal to the input of the counter when discharging the charge charged in the membrane capacitor Cm. In addition, the neuron circuit 200 changes the counting results of the counter in the second direction by providing a signal to the input of the counter when discharging the charge charged in the threshold capacitor Ct.

In the embodiment illustrated in FIG. 6, the neuron circuit 200 increases the counting results of the counter by applying a signal to an + input of the counter when discharging the membrane capacitor Cm. In addition, the neuron circuit 200 changes the counting results in the second direction that is a direction in which the counting results of the counter are reduced, by providing a signal to the − input of the counter when discharging the threshold capacitor Ct.

In the embodiment illustrated, the neuron circuit 200 increases the counting results of the counter by applying the signal to the + input of the counter when discharging the membrane capacitor Cm. In addition, the neuron circuit 200 changes the counting results in the second direction that is a direction in which the counting results of the counter are reduced by providing the signal to the − input of the counter when discharging the membrane capacitor Cm.

Therefore, information corresponding to the difference between the number of times the membrane capacitor Cm is charged above the discharge voltage and the number of times the threshold capacitor Ct is charged above the discharge voltage corresponds to the counting results maintained by the counter. Therefore, in the embodiment illustrated in FIG. 6, the counting results of the counter 210 increase corresponding to the number of times the membrane capacitor Cm is discharged and decrease corresponding to the number of times the threshold capacitor is discharged. The counting results of the counter correspond to a value obtained by subtracting the number of times the threshold capacitor is discharged from the number of times the membrane capacitor is discharged, i.e., corresponding to the difference between the membrane potential Vm and the threshold potential Vt.

However, in an embodiment not illustrated, the counting results of the counter decreases corresponding to the number of times the membrane capacitor is discharged and increases corresponding to the number of times the threshold capacitor is discharged. The counting results of the counter correspond to a value obtained by subtracting the number of times the threshold capacitor is discharged from the number of times the membrane capacitor is discharged, i.e., corresponding to the difference between the membrane potential and the threshold potential.

According to the present embodiment, information on relative sizes of the membrane potential and the threshold potential for firing the spike signals may be maintained without the problem of the overflow and without the loss of the information on the signals provided from each synapse.

The membrane potential Vm formed in the membrane capacitor Cm and the threshold potential Vt formed in the threshold capacitor Ct are compared by a comparator 220. In the illustrated embodiment, the comparator 220 outputs a logic high signal when the membrane potential is higher than the threshold potential.

In the embodiment illustrated in FIG. 6, the logic circuit 230 receives the counting results of the counter 210 and the output signal of the comparator 220, performs a logic operation, and outputs a firing signal F. In an embodiment, when the counting results of the counter 210 are positive, the counting results correspond to the number of times the membrane capacitor is discharged being greater than the number of times of the threshold capacitor is discharged, and when the signal output from the comparator 220 is logic high, the signal corresponds to the potential formed in the membrane capacitor being higher than the potential formed in the threshold capacitor. Accordingly, since the membrane potential is higher than the threshold potential, the logic circuit 230 outputs the firing signal F that causes the neuron to fire the spike signal. In addition, after outputting the firing signal, the neuron circuit 200 may reset both the membrane capacitor Cm and the threshold capacitor Ct.

In an embodiment, the neuron circuit 200 may include the counter 210, the comparator 220, and the logic circuit 230, and these circuits may be implemented as digital circuits. Accordingly, the spiking neural network 1 according to the present embodiment may be implemented as a hybrid signal circuit including an analog circuit and a digital circuit.

According to the present embodiment, it is possible to resolve the problem of overflow that has occurred in the related art.

Although the present invention has been described with reference to embodiments illustrated in the accompanying drawings in order to help the understanding of the present invention, this is only an exemplary embodiment for implementation, and those of ordinary skill in the art will understand that various modifications and other equivalent embodiments are possible therefrom. Accordingly, a true technical scope of the present invention is to be determined by the spirit of the appended claims.

What is claimed is:

1. A spiking neural network comprising a plurality of neurons,
wherein each of the plurality of neurons includes:
a plurality of synapses, each of which stores a positive valued weight or a negative valued weight;
a membrane capacitor that integrates signals output from one or more synapses storing the positive valued weight to form a membrane potential;
a threshold capacitor that integrates the signals output from the one or more synapses storing the negative valued weight to form a threshold potential; and
a neuron circuit that discharges the membrane capacitor when the membrane potential exceeds a discharge potential and discharges the threshold capacitor when the threshold potential exceeds the discharge potential,
wherein the neuron circuit fires the output signal according to a difference between the number of times the membrane capacitor is discharged and the number of times the threshold capacitor is discharged and a difference between the potential of the membrane capacitor and the potential of the threshold capacitor.

2. The spiking neural network of claim 1, wherein each of the plurality of synapses includes:
a first synaptic subunit that stores the positive valued weight; and
a second synaptic subunit that stores the negative valued weight,
wherein one of the first synaptic subunit and the second synaptic subunit is activated according to the stored weight.

3. The spiking neural network of claim 2, wherein the activated first synaptic subunits are connected to the same membrane capacitor within the same neuron to provide an output, and
the activated second synaptic subunits are connected to the same threshold capacitor within the same neuron to provide an output.

4. The spiking neural network of claim 1, wherein the neuron circuit includes a counter, and
the neuron circuit changes a counting result of the counter in the first direction by the number of times the membrane capacitor is discharged and changes the counting result of the counter in a second direction opposite to the first direction by the number of times the threshold capacitor is discharged according to the number of times the threshold capacitor is discharged.

5. The spiking neural network of claim 4, wherein the neuron circuit further includes a comparator, and
the comparator outputs a comparison result of comparing the membrane potential of the membrane capacitor with the threshold potential of the threshold capacitor.

6. The spiking neural network of claim 5, wherein the neuron circuit further includes a logic circuit, and
the logic circuit generates and outputs a firing signal when the counting result of the counter corresponds to the number of times the membrane capacitor is discharged being greater than the number of times the threshold capacitor is discharged and when the comparison result of the comparator corresponds to the membrane potential of the membrane capacitor being greater than the threshold potential of the threshold capacitor.

7. The spiking neural network of claim 6, wherein the neuron circuit resets both the membrane capacitor and the threshold capacitor when the firing signal is output.

8. The spiking neural network of claim 1, wherein the neuron circuit discharges the membrane capacitor by charging the membrane capacitor to a limiting potential lower than or equal to the discharge potential when the membrane potential is greater than or equal to than the discharge potential, and discharges the threshold capacitor by charging the threshold capacitor to a limiting potential lower than the discharge potential when the threshold potential is greater than or equal to the discharge potential.

9. A method of driving a spiking neural network including one or more neurons that include a plurality of synapses, a membrane capacitor for forming a membrane potential, a threshold capacitor for forming a threshold potential, and a neuron circuit, the method comprising:
integrating signals output from the one or more synapses storing a positive valued weight in the membrane capacitor and forming the membrane potential;
integrating signals output from the one or more synapses storing a negative valued weight in the threshold capacitor and forming the threshold potential;
discharging the membrane capacitor when the membrane potential exceeds a discharge potential, discharging the threshold capacitor when the threshold potential exceeds the discharge potential, and counting a difference in the number of times the membrane capacitor is discharged; and
firing an output signal according to the difference in the number of times of the discharge and a difference between a potential after the membrane capacitor is discharged and a potential after the threshold capacitor is discharged.

10. The method of claim 9, wherein each of the forming of the membrane potential, the discharging of the membrane capacitor, the forming of the threshold potential, and the discharging of the threshold capacitor are performed independently.

11. The method of claim 9, wherein, in the discharging of the membrane capacitor when the membrane potential exceeds the discharge potential, the discharging of the threshold capacitor when the threshold potential exceeds the discharge potential, and the counting of the difference in the number of times the membrane capacitor is discharged,
the neuron circuit changes a counting result of the counter in a first direction when discharging the membrane capacitor and changes the counting result of the counter in a second direction opposite to the first direction when discharging the threshold capacitor.

12. The method of claim 9, wherein each of the plurality of synapses includes:
a first synaptic subunit that stores the positive valued weight; and
a second synaptic subunit that stores the negative valued weight,
wherein one of the first synaptic subunit and the second synaptic subunit is activated according to the stored weight.

13. The method of claim 12, wherein the activated first synaptic subunits are connected to the same membrane capacitor within the same neuron to provide an output, and
the activated second synaptic subunits are connected to the same threshold capacitor within the same neuron to provide an output.

14. The method of claim 9, wherein the neuron circuit further includes a comparator, and
the comparator outputs a comparison result of comparing the membrane potential after the membrane capacitor is discharged with the threshold potential after the threshold capacitor is discharged.

15. The method of claim 14, wherein the neuron circuit further includes a logic circuit, and
the logic circuit generates and outputs a firing signal when a result in the counting corresponds to the number of times the membrane capacitor is discharged being greater than the number of times the threshold capacitor is discharged and a result in the comparing corresponds to the membrane potential of the membrane capacitor being greater than the threshold potential of the threshold capacitor.

16. The method of claim 14, further comprising, after the firing of the output signal, resetting the membrane capacitor and the threshold capacitor by discharging both the membrane capacitor and the threshold capacitor.

17. The method of claim 9, wherein the discharging of the membrane capacitor is performed by discharging the membrane capacitor by charging the membrane capacitor with a limiting potential lower than the discharge potential, and
the discharging of the threshold capacitor is performed by discharging the threshold capacitor by charging the threshold capacitor with the limiting potential lower than the discharge potential.
